(19) United States
(12) Patent Application Publication
(10) Pub. No.: US 2005/0204346 A1
(43) Pub. Date: Sep. 15, 2005

(54) Using sampling data for program phase detection

(75) Inventor: Robert L. Davies, Fremont, CA (US)

Correspondence Address: VENABLE LLP, P.O. BOX 34385, WASHINGTON, DC, 20045-9998, US

(73) Assignee: Intel Corporation, Santa Clara, CA (US)

(21) Appl. No.: 10/795,519

(22) Filed: Mar. 9, 2004

(51) Int. Cl. G06F 9/44

(52) U.S. Cl. 717/127; 717/131

(57) ABSTRACT

Sampling of program execution may be used to provide sampling data useful in identifying phases of a program.

### BACKGROUND OF THE INVENTION

Processor designers rely heavily on representative benchmark simulations to evaluate various design alternatives. However, accurate modeling of a complex design may reduce simulation speed, in spite of increasing processing power, thereby restricting the ability to study design tradeoffs. Researchers may use ad hoc solutions, such as simulating only a small fraction of the overall benchmark, in the hope that the simulated fraction is a good representative of the overall behavior. However, recent studies show that programs exhibit different behaviors during different execution phases that occur over a long time period. Attempts to avoid this problem by simulating several samples of program execution must be, by nature, based on code instrumentation and simulations, which restricts the ability to apply them to a wide-range of applications running on complex native hardware.

### BRIEF DESCRIPTION OF THE DRAWINGS

Various exemplary features and advantages of embodiments of the invention will be apparent from the following, more particular description of exemplary embodiments of the present invention, as illustrated in the accompanying drawings wherein like reference numbers generally indicate identical, functionally similar, and/or structurally similar elements.

FIG. 1 depicts an exemplary embodiment of a system according to an exemplary embodiment of the invention;

FIG. 2 depicts an exemplary embodiment of a method according to an exemplary embodiment of the invention;

FIG. 3 depicts an exemplary embodiment of a method according to an exemplary embodiment of the invention; and

FIG. 4 depicts an exemplary embodiment of a computer and/or communications system as can be used for several components in an exemplary embodiment of the invention.

### DETAILED DESCRIPTION OF EXEMPLARY EMBODIMENTS OF THE PRESENT INVENTION

Exemplary embodiments of the invention are discussed in detail below. While specific exemplary embodiments are discussed, it should be understood that this is done for illustration purposes only. A person skilled in the relevant art will recognize that other components and configurations may be used without parting from the spirit and scope of the invention.

Embodiments of the present invention may provide a system and/or method for detecting phases of a program that may be executed by a processor. As referred to herein, a phase of a program bay be defined by the loops of the program and their subordinates, as well as the data with which the loop is called. Exemplary embodiments of the invention may process sampling addresses to obtain the processor state in each sample and cluster the sampling addresses using clustering algorithms, for example, algorithms as would be known by a person having ordinary skill in the art, to detect the phases of the program.

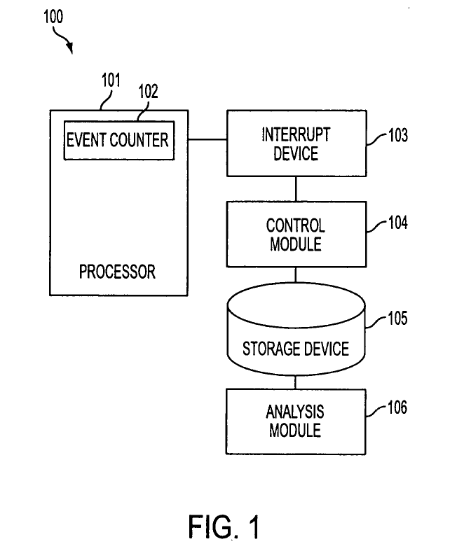

Referring now to the drawings, FIG. 1 depicts an exemplary system 100 that may be used to detect the phases of a program. In exemplary embodiments of the invention, a program may be any program that is capable of being executed on a computer or native hardware, for example. System 100 may include a processor 101. Processor 101 may have one or more embedded event counters 102. The embedded event counters 102 may be used by system 100 to collect performance metrics such as, e.g., Extended Instruction Pointers (EIPs) and several other program metrics including, but not limited to, event counter totals, process IDs, module names, cycles per instruction (CPIs), thread IDs, and processor number. In an exemplary embodiment of the invention, as would be understood by a person having ordinary skill in the art, an EIP may be, e.g., a 32-bit or 64-bit instruction pointer that may indicate to system 100 the location in memory where the next instruction resides, for example.

System 100 may also include interrupt device 103, control module 104, storage device 105, and analysis module 106. Interrupt device 103 may interrupt execution of the program at regular intervals of instructions executed (e.g., once every one million instructions) so that the performance metrics, for example, may be recorded. Control module 104 may obtain a state of the processor during the interrupt and generate sampling data based on the state of the processor. To obtain the state of the processor, control module 104 may record the EIPs and event counter totals (e.g., clocktick count and instruction count), for example. To generate sampling data, control module 104 may write the EIPs, process ID, module name, and cycles per instruction, for example, to storage device 105. This sampling data may then be used by analysis module 106 during phase analysis.

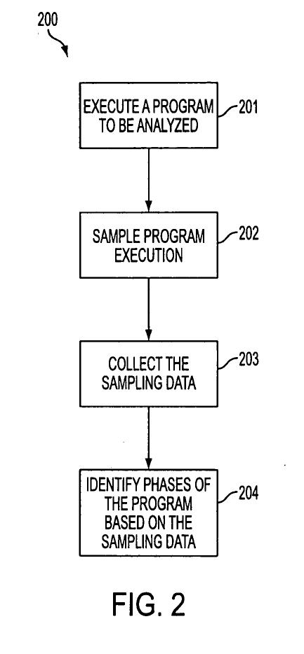

FIG. 2 depicts a flow chart 200, which illustrates an exemplary embodiment for identifying phases of a program according to exemplary embodiments of the invention. In block 201, a program that is to be analyzed may be executed on a processor, for example. In an exemplary embodiment of the invention, the program may be executed on any machine, independent of the underlying machine configuration, such as the number of function units and cache sizes.

In block 202, program execution may be sampled. In an exemplary embodiment of the invention, program execution may be sampled in real-time, for example, by monitoring embedded event counters in a processor.

In block 203, the sampling data may be collected. To collect sampling data, a control module, such as, e.g., control module 106, may collect EIPs and other performance metrics. In an exemplary embodiment of the invention, other data such as, e.g., performance metrics, that is collected may include, but is not limited to process IDs, module names, and CPIs. Once the data is collected, a control module, for example, may generate sampling data and store it in a storage device, for example, for later analysis.

In block 204, the phases of the program may be identified based on the sampling data. To identify the phases of a program, extended instruction pointer vectors (EIPVs) may be constructed from the sampling data. In exemplary embodiments of the invention, known algorithms, such as, e.g., the k-means, Spectral, and Agglomerative algorithms, may then be used to cluster the EIPVs, as would be understood by a person having ordinary skill in the art.

As an example, to construct EIPVs for clustering, the execution of the program may be divided into equal intervals, each of length 100 million instructions, for example. Each interval may be “signed” by a vector that corresponds to the normalized histogram of EIPs interrupted during program execution. For example, let N be the total number of unique EIPs recorded throughout the complete execution of the program. The j^{th} interval of 100 million executed instructions may then be represented by the N-dimensional vector xⱼ=[x₁ⱼx₂ⱼ . . . x_{Nj}]^{T}, where xᵢⱼ, is the total number of times the i^{th} EIP has been sampled during the execution interval divided by the total number of EIPs collected (vector xⱼ is normalized so that the sum of its entries xᵢⱼ equals one). If the code is sampled at a rate of once every million instructions executed, for example, then each histogram vector xⱼ may be computed on the basis of 100 consecutive samples. In such an embodiment, xⱼ may be called the j^{th} EIPV. Following this representation, the Euclidian norm in N-dimensional space may be a natural distance metric to measure similarity between program segments. In other words, the n^{th} and m^{th} EIPVs may be declared similar if the Euclidian distance d(xₙ, xₘ)=∥xₙ−xₘ∥ is “small”, for example, within some predetermined amount. As will be understood by a person having ordinary skill in the art, because each EIPV covers a fixed number of instructions executed, the EIPV may be a machine independent attribute.

Once the EIPVs have been constructed, the EIPVs may then be clustered for program phase detection in block 204. Continuing with the above example, a program that is executed may be represented by its set of N-dimensional EIP vectors X={x₁, x₂, . . . x_{M}}, where M is the total number of instruction segments executed (or total number of instruction segments in units of 100 million, for example). The k-means algorithm may then be applied on the set X to identify the k most representative clusters corresponding to the k program phases.

In an exemplary embodiment of the invention, random projection may then be used to reduce the dimensionality of the vectors, for example, without losing separability between clusters. Random projection may consist of replacing the original set of EIPVs xⱼ (j=1, . . . M), by their orthogonal projections x′ⱼ onto a randomly selected linear subspace of dimension D<<N. In an exemplary embodiment of the invention, D=15 may be a suitable target dimensionality for random projection. In an exemplary embodiment of the invention, k-means clustering may then be applied to the set of “projected” EIPVs X′={x′₁, x′₂, . . . , x′_{M}}.

The above example illustrates the effectiveness of the EIPV approach in identifying phase behavior. In an exemplary embodiment of the invention, Bayesian Information Criterion (BIC) may be used to compute a number of distinct phases k of a program that approaches an optimum value, in connection with use of k-means clustering. As will be understood by a person having ordinary skill in the art, the BIC may be used to identify a good value for the number of clusters (or phases) k. For a given choice of k the BIC score for an EIPV X′={x′₁, x′₂, . . . , x′_{M}} may be written as follows:
BIC(k)=log(pₖ(X′))−k(D+1)/2 log M,
where pₖ(X′) is a determined (by k-means clustering) probability distribution of the data with estimated parameters, i.e., the centroids of clusters in k-means clustering, which may provide a measure of the distortion from the underlying data, and k(D+1) is the total number of parameters (accounting for dimensionality).

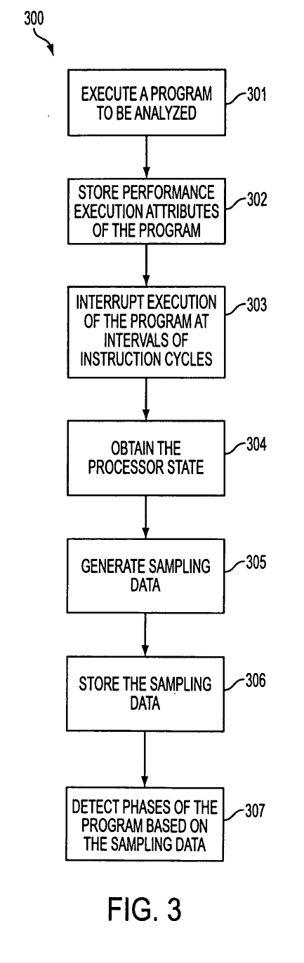

FIG. 3 depicts flow chart 300, which illustrates an exemplary embodiment for identifying phases of a program according to exemplary embodiments of the invention. In block 301, a program to be analyzed may be executed. In block 302, performance execution attributes of the program may be stored in embedded event counters of a processor. In block 303, execution of the program may be interrupted. As discussed above, execution of the program may be interrupted at intervals of instruction cycles, clock cycles, or time. In an exemplary embodiment of the invention, the program may be interrupted every 10,000 instruction cycles, 10,000 clock cycles, or 1,000 times per second, for example. In an exemplary embodiment of the invention, a user may select which period is used.

In block 304, the state of the processor may be obtained. To obtain the state of the processor, data, such as, but not limited to, EIPs, process IDs, module name, CPIs, and the like may be recorded. Once the data is recorded, sampling data may be generated in block 305.

In block 306, the sampling data may be stored in a storage device for later use during phase detection, for example. In block 307, the phases of the program may be detected based on the sampling data. As discussed above, EIPVs may be constructed and clustered for program phase detection. In an exemplary embodiment of the invention, the EIPVs may be clustered using the k-means algorithm, as will be understood by a person having ordinary skill in the art.

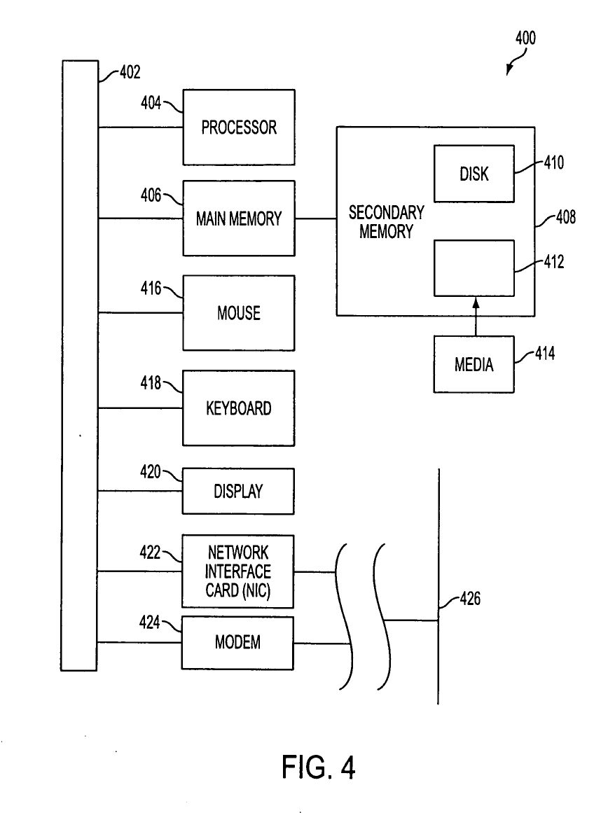

FIG. 4 depicts an exemplary embodiment of a computer and/or communications system as may be used for several components of the system in an exemplary embodiment of the present invention. FIG. 4 depicts an exemplary embodiment of a computer 400 as may be used for several computing devices in exemplary embodiments of the present invention. Computer 400 may include, but is not limited to: e.g., any computer device, or communications device including, e.g., a personal computer (PC), a workstation, a mobile device, a phone, a handheld PC, a personal digital assistant (PDA), a thin client, a fat client, an network appliance, an Internet browser, a paging, or alert device, a television, an interactive television, a receiver, a tuner, a high definition (HD) television, an HD receiver, a video-on-demand (VOD) system, a server, or other device. Computer 400, in an exemplary embodiment, may comprise a central processing unit (CPU) or processor 404, which may be coupled to a bus 402. Processor 404 may, e.g., access main memory 406 via bus 402. Computer 400 may be coupled to an Input/Output (I/O) subsystem such as, e.g., a network interface card (NIC) 422, or a modem 424 for access to network 426. Computer 400 may also be coupled to a secondary memory 408 directly via bus 402, or via main memory 406, for example. Secondary memory 408 may include, e.g., a disk storage unit 410 or other storage medium. Exemplary disk storage units 410 may include, but are not limited to, a magnetic storage device such as, e.g., a hard disk, an optical storage device such as, e.g., a write once read many (WORM) drive, or a compact disc (CD), or a magneto optical device. Another type of secondary memory 408 may include a removable disk storage device 412, which can be used in conjunction with a removable storage medium 414, such as, e.g. a CD-ROM, or a floppy diskette. In general, the disk storage unit 410 may store an application program for operating the computer system referred to commonly as an operating system. The disk storage unit 410 may also store documents of a database (not shown). The computer 400 may interact with the I/O subsystems and disk storage unit 410 via bus 402. The bus 402 may also be coupled to a display 420 for output, and input devices such as, but not limited to, a keyboard 418 and a mouse or other pointing/selection device 416.

The embodiments illustrated and discussed in this specification are intended only to teach those skilled in the art various ways known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that the invention may be practiced otherwise than as specifically described.

1. A method comprising:
sampling program execution;
collecting sampling data; and
identifying phases of the program based on the sampling data.

2. The method according to claim 1, said sampling comprising:
monitoring performance execution attributes of the program stored in embedded event counters of a processor.

3. The method according to claim 2, further comprising:
executing the program on actual hardware.

4. The method according to claim 1, wherein said collecting comprises:
collecting at least one of sampling addresses or cycles per instruction (CPIs).

5. The method according to claim 4, wherein the sampling addresses comprise extended instruction pointers (EIPs).

6. The method according to claim 1, wherein said identifying comprises:
clustering extended instruction pointer vectors (EIPVs).

7. The method according to claim 5, wherein the EIPVs are clustered using a k-means algorithm.

8. The method according to claim 5, further comprising:
optimizing the EIPVs using a Bayesian Information Criteria (BIC).

9. A system comprising:
a processor to execute a program, the processor having at least one embedded event counter to count instruction cycles of the program and to store performance execution attributes of the program;
an interrupt device communicatively coupled to the processor to interrupt execution of the program at intervals of instruction cycles;
a control module communicatively coupled to the processor to obtain a state of the processor during the interrupt and generate sampling data based on the state of the processor;
a storage device communicatively coupled to the processor to store sampling data; and
an analysis module communicatively coupled to the processor to detect the phases of the program based on the sampling data.

10. The system according to claim 9, wherein said control module is further adapted to monitor the performance execution attributes of the program.

11. The system according to claim 9, wherein said control module is further adapted to collect at least one of sampling addresses or cycles per instruction (CPIs).

12. The system according to claim 11, wherein the sampling addresses comprise extended instruction pointers (EIPs)

13. The system according to claim 9, wherein said analysis module is further adapted to cluster extended instruction pointer vectors (EIPVs).

14. The system according to claim 13, wherein the EIPVs are clustered using a k-means algorithm.

15. The system according to claim 12, wherein the analysis module is adapted to optimize the EIPVs using a Bayesian Information Criteria (BIC).

16. The system according to claim 9, wherein the interrupt device is adapted to interrupt execution of the program at intervals ranging between 1,000 and 100,000 instruction cycles.

17. A machine accessible medium containing program instructions that, when executed by a processor, cause the processor to:
sample program execution;
collect sampling data; and
identify phases of the program based on the sampling data.

18. The machine accessible medium according to claim 17, further comprising instructions that, when executed by a processor, cause the processor to:
monitor performance attributes of the program stored in embedded event counters of the processor.

19. The machine accessible medium according to claim 17, further comprising instructions that, when executed by a processor, cause the processor to:
collect at least one of sampling addresses or cycles per instruction.

20. The machine accessible medium according to claim 19, wherein the sampling addresses comprise extended instruction pointers (EIPs).

21. The machine accessible medium according to claim 17, further comprising instructions that, when executed by a processor, cause the processor to:
cluster extended instruction pointer vectors (EIPVs).

22. The machine accessible medium according to claim 21, further comprising instructions that, when executed by a processor, cause the processor to:
cluster the extended instruction pointer vectors (EIPVs) using a k-means algorithm.

23. The machine accessible medium according to claim 21, further comprising instructions that, when executed by a processor, cause the processor to:
optimize the EIPVs using a Bayesian Information Criteria (BIC).

24. A machine accessible medium containing instructions that, when executed by a processor, cause the processor to:
execute a program;
store performance execution attributes of the program;
interrupt execution of the program at intervals of instruction cycles;
obtain a state of the processor during the interrupt;
generate sampling data based on the state of the processor;
store sampling data; and
detect the phases of the program based on the sampling data.

25. The machine accessible medium according to claim 24, further comprising instructions that, when executed by a processor, cause the processor to:
monitor the performance execution attributes of the program.

26. The machine accessible medium according to claim 24, further comprising instructions that, when executed by a processor, cause the processor to:
collect at least one of sampling addresses or cycles per instruction (CPIs).

27. The machine accessible medium according to claim 26, wherein the sampling addresses are extended instruction pointers (EIPs)

28. The machine accessible medium according to claim 24, further comprising instructions that, when executed by a processor, cause the processor to:
cluster extended instruction pointer vectors (EIPVs).

29. The machine accessible medium according to claim 28, wherein the EIPVs are clustered using a k-means algorithm.

30. The machine accessible medium according to claim 28, further comprising instructions that, when executed by a processor, cause the processor to:
optimize the EIPVs using a Bayesian Information Criteria (BIC).
